(19) United States
(12) Patent Application Publication
(10) Pub. No.: US 2005/0109186 A1
(43) Pub. Date: May 26, 2005

(54) Sandpaper cutter

(76) Inventors: Michael Robert O'Donnell, Orchard Park, NY (US); Paul David Rowell, Elma, NY (US)

Correspondence Address: MICHAEL ROBERT O'DONNELL, 3663 ABBOTT ROAD, ORCHARD PARK, NY, 14127, US

(21) Appl. No.: 10/997,326

(22) Filed: Nov. 24, 2004

Related U.S. Application Data
(60) Provisional application No. 60/525,221, filed on Nov. 26, 2003.

(51) Int. Cl. B26F 3/02

(52) U.S. Cl. 83/856; 225/6

(57) ABSTRACT

A sandpaper cutter apparatus for sizing sandpaper from bulk sheets into sander-sized sheets. A preferred form of the invention is of a rectangular shaped apparatus. The upper portion of this apparatus contains a sharpened or serrated cutting blade placed longitudinally and on the planer face of the apparatus with its cutting edge placed upward. This cutting blade is slightly raised off the planer surface it is attached to, thus creating a gap where the sandpaper may be vertically inserted for cutting. Just above and to both sides of the cutting blade ends, are two holes for mounting the apparatus to a wall or work surface if desired. Removable sizing pins are located in the lower portion of the apparatus and numerical characters are stamped in the middle of the planer surface to further aid the operator in sizing the sandpaper sheet for cutting.

### FIELD OF THE INVENTION

The present invention relates to cutting sandpaper and, more particularly, to a sandpaper cutter which cuts 9×11 sandpaper sheets into various sizes for hand or power sanders.

### BACKGROUND OF THE INVENTION

Various types of manual or powered sanders are designed to accept particular sizes of sandpaper. These particular sandpaper sizes can be purchased cut to size but are often much more expensive than sandpaper purchased in bulk sizes. The bulk sheets of sandpaper are much cheaper, but a cutting operation of some sort must be performed in order to convert the bulk size into the desired individual size needed. Cutting sandpaper at all is a problem in itself. Being made of abrasive compounds, the nature of sandpaper is to quickly dull knife edges, scissors, razors and the like. Furthermore, manually measuring each piece to be cut is very time consuming and lends itself to inaccuracy. Folding sheets of sandpaper to fit sanding devices is not acceptable because sandpaper sheets tend to wrinkle thus creating troublesome sanding marks in the surface of the project.

In prior art, attempts have been made to provide an easy and efficient way to cut abrasive sheets to size for a particular size sander. Gish, U.S. Pat. No. 6,138,884 issued Oct. 31st, 2000, discloses a Sander Mate apparatus having a substantially regular rectangular shape. A handle integral with the top surface is shown and a cutting edge is pictured on one longitudinal edge and fastened to the bottom surface. Measuring lines are printed onto the surface of the apparatus for sizing of the sandpaper prior to cutting. While the design of this device is quite simple, the forfeiture of any positive stops or guides appears to create some difficulty in its use. To cut a sheet of sandpaper with this device, the paper must first be placed onto a flat work surface abrasive side down, more than likely damaging that surface. The Sander Mate is then placed on top of the sandpaper carefully aligning the edge of the sandpaper with the desired sizing line of the Sander Mate. This visual alignment will only lend itself to inaccuracy and inconsistent sizing. Only a visual alignment is possible, with no positive stop to insure correct positioning. If the operator doesn't exert enough downward pressure, the sandpaper will slip, thus resulting in an undesired size. Also, to visually make sure that the edge of the sandpaper is exactly on the desired reference line would be very time consuming and therefore result in an additional cost in this operation.

Moulton et al., U.S. Design Pat. No. 296,864 issued Jul. 6, 1988 shows a design patent for a Sandpaper Cutter. Since there is no functionality description for a design patent it is difficult to understand its use. I can only ascertain that Moulton's device seems to be molded from some sort of plastic as one solid unit. A cutting edge molded such as this would quickly be worn down, thus rendering the apparatus useless. The aligning rails or stops also appear to be molded into this device as well and are of a fixed nature. With the stops being in a fixed position on the cutting surface, when the paper is placed on one of the lower sizing rails, the preceding rails above will cause the sandpaper to arch over them therefore making the sandpaper hard to hold flat upon the surface of the device causing slippage and thus resulting in inaccurate cuts.

It is therefore an object of the invention to . . . provide an easy to use apparatus for sizing bulk sandpaper sheets into individual sander sized sheets.

It is another object of the invention to . . . provide an improved device for measuring and cutting standard sized sheets of abrasive material.

It is another object of the invention to . . . provide an inexpensive apparatus for sizing bulk sandpaper sheets into individual sander sized sheets.

It is another object of the invention to . . . provide a relatively small and durable apparatus for sizing bulk sandpaper sheets into individual sander sized sheets.

### SUMMARY OF THE INVENTION

In accordance with the present invention, there is provided . . . A sandpaper cutter apparatus for sizing sandpaper from bulk sheets into sander-sized sheets. A preferred form of the invention is of a rectangular shaped apparatus. The upper portion of this apparatus contains a sharpened or serrated cutting blade placed longitudinally and parallel to the planer face of the apparatus with its cutting edge facing opposite to the lower portion of the apparatus. This cutting blade is slightly raised off the planer surface it is attached to, thus creating a gap where the sandpaper may be inserted for cutting. Just above and to both sides of the cutting blade ends, are two holes for mounting the apparatus to a wall or work surface if desired. Removable sizing pins are located in the lower portion of the apparatus and numerical characters are stamped in the middle of the planer surface to further aid the operator in sizing the sandpaper sheet for cutting. The sandpaper sheet is slid between the planer surface of the apparatus and the cutting blade with its abrasive side toward the planer surface, and its leading edge allowed to stop at the desired sizing pin. Once the sandpaper sheet is slid between the cutting blade and the planer surface and its leading edge allowed to rest on the desired sizing pins, the operator then gently presses the lower section of the sandpaper against the planer surface with one hand while he subsequently pulls the upper section of the sandpaper toward himself and across and away from the cutting edge with his other hand. Sandpaper may be cut to a different size by simply removing the locating pin from one hole in the planer surface and positioning it into another hole in the planer surface of the apparatus.

Using this sandpaper cutter of the present invention, a user may quickly reduce a number of bulk sandpaper sheets into a multitude of individual sized sanding sheets. The sizing of just a minimal amount of bulk sandpaper sheets, will allow the user to quickly recover the cost of this inexpensive and novel device.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a sandpaper cutter; and

FIG. 2 is an enlarged view of a Shim.

For purposes of clarity and brevity, like elements and components will bear the same designations and numbering throughout the FIGURES.

### DESCRIPTION OF THE PREFERRED EMBODIMENT

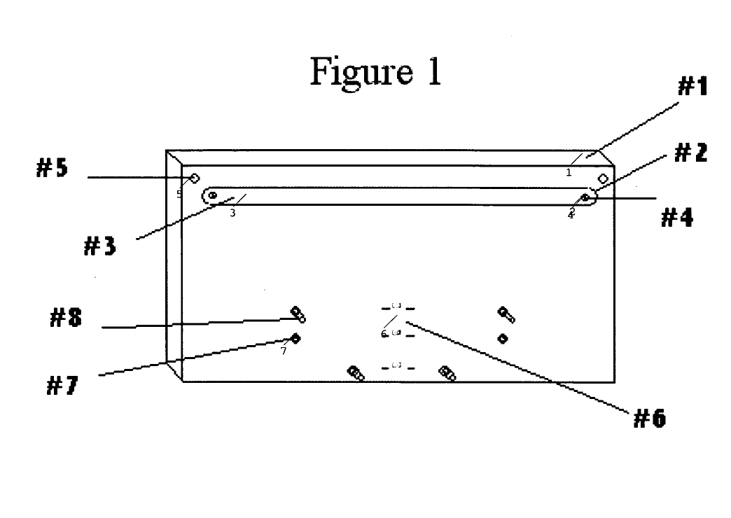

FIG. 1 is a perspective view of the sandpaper cutter, in accordance with the invention. The sandpaper cutter is used to cut standard nine by eleven inch sheets of sandpaper into various sizes for use in hand and power sanding tools.

FIG. 1 shows a rectangular shaped Sandpaper Cutter Base 1, approx. 13″ wide×7″ high. The preferred embodiment of the invention for the Sandpaper Cutter Base 1 is to be of metal, however, it may be readily fabricated of, wood, plastic or any other suitable material with optional finish and trim. The Sandpaper Cutter Base 1 may also be as an assemblage of multiple pieces attached using adhesive, screws, rivets, welds or the like.

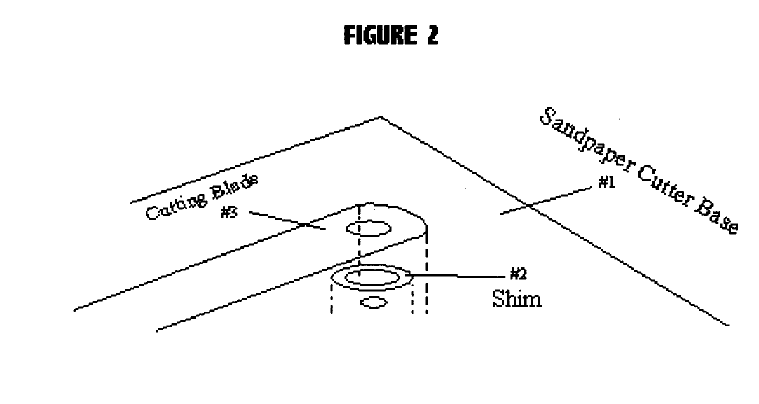

In the upper quarter of the horizontal section of the Sandpaper Cutter Base 1 is the Cutting Blade 3 which is of a serrated steel construction but may be of a continuous sharp edge and other appropriate material for cutting purposes. A gap between the Cutting Blade 3 and the Sandpaper Cutter Base 1 is provided by placement of a metal shim 2. FIG. 2 is an enlarged view of the shim 2 area and shows how it is situated at each fastenable end of the Cutting Blade 3. While it is in the preferred embodiment to use a metal shim 2 for creating the gap, any other suitable shim 2 material may be used or other procedure and means applied to raise the cutter blade from the planer surface of the Sandpaper Cutter Base 1. Each end of the Cutting Blade 3 is replaceably fastened by the Cutting Blade 3 3ounting Screw to the Sandpaper Cutter Base 1. A gap between the Cutting Blade 3 and the Sandpaper Cutter Base 1 is provided to enable a sheet of sandpaper to pass through. This gap is only slightly larger than the thickness of a standard bulk sized sheet of sandpaper. Above and just past each end of the Cutting Blade 3 is provided a Mounting Hole 5 for use, if desired, in attaching to a wall or work surface.

Measuring Indicia 6 is permanently engraved in the planer surface of the Sandpaper Cutter Base 1 and is located in the lower half of the horizontal portion of the Sandpaper Cutter Base 1 and centered to its width. These Measuring Indicia 6 act as an aid and allow the user to quickly identify which Locating Pin 8 set to use for the desired size cut. Each Locating Pin 8 has a diameter which is in direct relationship to the diameter of the Locating Pin 8 8ole and allows for a positive fit for accurate placement when the Locating Pin 8 is attached directly into the Locating Pin 8 8ole. While in the preferred embodiment the Locating Pin 8 is of a metal material and round, various other: shapes, material types, operative procedures of and locating devices may be utilized to facilitate the repetitive accurate placement of bulk sandpaper sheets for sizing.

In its operation, with the Measuring Indicia 6 as a reference, a user inserts a Locating Pin 8 set (two pins) into a Locating Pin 8 8ole set (two holes) corresponding to the desired size piece of sandpaper to be cut. The user may then insert a bulk sized sheet of sandpaper, with its abrasive side toward the planer surface of the Sandpaper Cutter Base 1. The bulk sandpaper sized sheet is then slid between the planer surface of the Sandpaper Cutter Base 1 and the Cutting Blade 3. The bulk sized piece of sandpaper is then let to rest on the desired Locating Pin 8 set. The user, using one hand, then applies light pressure to the lower portion of the bulk sandpaper sheet to push it against the planer surface of the Sandpaper Cutter Base 1 thus securing it from movement. Using the other hand, the user would then grab a top corner of the upper portion of the bulk sized sandpaper sheet and swiftly and continuously pull it towards himself and away from the Sandpaper Cutter Base 1 until the bulk sandpaper sheet is cut completely across. The user now has the desired size of sandpaper needed.

Now the subject of this patent application may be more generally described as follows. The sandpaper cutter is an assembly made up of eight parts, namely a means for enabling the cutting of sandpaper, a means for cutting the sandpaper, a means for creating a gap between the Sandpaper Cutter Base 1 and the Cutting Blade 3, a means for attaching the Cutting Blade 3 to the Sandpaper Cutter Base 1, a means for mounting the Sandpaper Cutter Base 1 to a wall or work surface if desired, a means for identifying sizing locations, a means for enabling the placement of a locating device, a means for locating a sandpaper sheet for resizing.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A sandpaper cutter for facilitating the cutting of sandpaper comprising:
means for enabling the cutting of sandpaper;
means for cutting sandpaper, replaceably fastened to said means for enabling the cutting of sandpaper;
means for attaching cutting blade to sandpaper cutter base, removably connected to said means for cutting sandpaper;
means for enabling the placement of the locating pin, permanently connected to said means for enabling the cutting of sandpaper;
means for creating clearance between sandpaper cutter base and sandpaper cutting blade, removably engaged to said means for enabling the cutting of sandpaper; and
means for accurate placement of bulk sandpaper sheets, removably connected to said means for enabling the placement of the locating pin.

2. The sandpaper cutter in accordance with claim 1, wherein said means for enabling the cutting of sandpaper. comprises a sandpaper cutter base.

3. The sandpaper cutter in accordance with claim 1, wherein said means for cutting sandpaper comprises a cutting blade.

4. The sandpaper cutter in accordance with claim 1, wherein said means for attaching cutting blade to sandpaper cutter base. comprises a cutting blade mounting screw.

5. The sandpaper cutter in accordance with claim 1, wherein said means for enabling the placement of the locating pin. comprises a locating pin hole.

6. The sandpaper cutter in accordance with claim 1, wherein said means for creating clearance between sandpaper cutter base and sandpaper cutting blade comprises a shim.

7. The sandpaper cutter in accordance with claim 1, wherein said means for accurate placement of bulk sandpaper sheets comprises a locating pin.

8. A sandpaper cutter for facilitating the cutting of sandpaper comprising:
a sandpaper cutter base, for enabling the cutting of sandpaper;
a cutting blade, for cutting sandpaper, replaceably fastened to said Sandpaper Cutter Base;
a cutting blade mounting screw, for attaching cutting blade to sandpaper cutter base, removably connected to said Cutting Blade;
a locating pin hole, for enabling the placement of the locating pin, permanently connected to said Sandpaper Cutter Base;
a shim, for creating clearance between sandpaper cutter base and sandpaper cutting blade, removably engaged to said Sandpaper Cutter Base; and
a locating pin, for accurate placement of bulk sandpaper sheets, removably connected to said Locating Pin Hole.

9. The sandpaper cutter as recited in claim 8, further comprising:
a mounting hole, for mounting sandpaper cutter base to wall or work surface, permanently constructed to said Sandpaper Cutter Base.

10. The sandpaper cutter as recited in claim 8, further comprising:
a measuring indicia, for a visual aid to facilitate the cutting of sandpaper to specific sizes, permanently engraved to said Sandpaper Cutter Base.

11. The sandpaper cutter as recited in claim 9, further comprising:
a measuring indicia, for a visual aid to facilitate the cutting of sandpaper to specific sizes, permanently engraved to said Sandpaper Cutter Base.

12. A sandpaper cutter for facilitating the cutting of sandpaper comprising:
a sandpaper cutter base, for enabling the cutting of sandpaper;
a cutting blade, for cutting sandpaper, replaceably fastened to said Sandpaper Cutter Base;
a cutting blade mounting screw, for attaching cutting blade to sandpaper cutter base, removably connected to said Cutting Blade;
a mounting hole, for mounting sandpaper cutter base to wall or work surface, permanently constructed to said Sandpaper Cutter Base;
a measuring indicia, for a visual aid to facilitate the cutting of sandpaper to specific sizes, permanently engraved to said Sandpaper Cutter Base;
a locating pin hole, for enabling the placement of the locating pin, permanently connected to said Sandpaper Cutter Base;
a shim, for creating clearance between sandpaper cutter base and sandpaper cutting blade, removably engaged to said Sandpaper Cutter Base; and
a locating pin, for accurate placement of bulk sandpaper sheets, removably connected to said Locating Pin Hole.
